(19) United States
(12) Patent Application Publication
(10) Pub. No.: US 2013/0066752 A1
(43) Pub. Date: Mar. 14, 2013

(54) Automating Life Cycle Inventory Data Collection

(71) Applicants: Neil Gregory Huizenga, Bellevue, WA (US); Daniel Christian Brown, Bellevue, WA (US); Michael Victor Ehrenberg, Seattle, WA (US)

(72) Inventors: Neil Gregory Huizenga, Bellevue, WA (US); Daniel Christian Brown, Bellevue, WA (US); Michael Victor Ehrenberg, Seattle, WA (US)

(73) Assignee: MICROSOFT CORPORATION, Redmond, WA (US)

(21) Appl. No.: 13/228,405

(22) Filed: Sep. 8, 2011

(51) Int. Cl. G06Q 10/08

(52) U.S. Cl. 705/28

(57) ABSTRACT

Collection of life cycle inventory (“LCI”) data for all phases of the life of goods and/or services is provided. Suppliers of goods and/or services may log into a LCI and assessment data hub via one or more access points for entering LCI data on all phases of development, production use and/or disposal of their goods and/or services. Access to the data hub, as a central data collection point, requires authentication of accessing suppliers via a security framework associated with the data hub. LCI data may be provided via a structured data template, or raw business or business transaction data may be entered in association with a unit process model requested by the supplier. Entered LCI data may be validated as being appropriate for the associated data type and the entered data may be audited to ensure accuracy of the data

### BACKGROUND

In the global economy, concerns about environmental and social responsibility in product manufacturing, distribution and use are driving the need to provide information about products to consumers at all phases of a product's life cycle (from growth/manufacturing to disposal) to allow consumers to know whether a given product was produced or used in a responsible manner or to allow consumers to know the environmental and/or social impact of a given product for comparing the product against other products. For example, a purchaser of an article of clothing may believe the article of clothing was manufactured in an environmentally and socially responsible manner, but in reality, a portion of the manufacturing life cycle, for example, cotton growth, may have been produced using a variety of fertilizers and pesticides the purchaser may find unacceptable. Moreover, the cotton may have been harvested in a manner that did not meet acceptable labor standards (for example, use of child labor). Persons or entities desiring such information may exist at all phases of production or use, for example, down stream component purchasers, retailers, end users, or even disposers of a depleted or used product.

Collection of data at all phases of a product's life cycle in a manner that ensures reliability and security of the data, as well as, anonymity (if required) of the provider of the data is often difficult to achieve. Reliability of the data is imperative if the information provided for a product is to have any value. Security and anonymity of the data and source of the data are similarly important to encourage suppliers of the data to provide timely and accurate data, particularly where data from one supplier may be proprietary and should not be released to other suppliers.

It is with respect to these and other considerations that the present invention has been made.

### SUMMARY

Embodiments of the present invention solve the above and other problems by providing for automation of life cycle inventory data collection for goods and/or services at all stages of the life of the goods and/or services. According to embodiments, suppliers of goods and/or services may log into a life cycle inventory and assessment data hub via one or more access points for entering life cycle inventory data on all phases of development, production use and/or disposal of their goods and/or services. Access to the data hub, as a central data collection point, requires authentication of accessing suppliers via a security framework associated with the data hub. After suppliers gain access to the data hub, life cycle inventory data may be provided via a structured data template, or raw business or business transaction data may be entered in association with a unit process model requested by the supplier. Entered life cycle inventory data may be validated as being appropriate for the associated data type and the entered data may be audited to ensure accuracy of the data.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a simplified block diagram illustrating a life cycle of one or more goods and/or services from production through consumption and/or disposal.

FIG. 2 is a simplified block diagram of a data hub for receiving and processing life cycle inventory data.

FIG. 3 is a simplified block diagram showing two data input documents.

FIG. 4 is a simplified block diagram of a life cycle inventory input/output security framework.

FIG. 5 is a flow chart illustrating a method of receiving life cycle inventory data.

FIG. 6 is a flow chart illustrating a method of validating and auditing life cycle inventory input from one or more data providers.

FIG. 7 is a flow chart illustrating a method of processing received life cycle inventory data.

FIG. 8 is a simplified block diagram of a computing device with which embodiments of the present invention may be practiced.

FIGS. 9A and 9B are simplified block diagrams of a mobile computing device with which embodiments of the present invention may be practiced.

FIG. 10 is a simplified block diagram of a distributed computing system in which embodiments of the present invention may be practiced.

### DETAILED DESCRIPTION

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

As briefly described above, embodiments of the present invention are directed to automating life cycle inventory data collection for one or more goods and/or services. According to embodiments, when any good, for example, a shirt or other article of clothing, an automobile, an appliance, and the like, or any service, for example, energy production, telecommunications services, and the like are manufactured or provided, a multitude of components and processing are involved in the production and utilization of such goods and/or services on both a cradle-to-gate basis and a cradle-to-grave basis. A cradle-to-gate basis includes all phases of the production and use of goods or services from initial production or development through presentation to end users, and a cradle-to-grave basis includes all phases of the production and use of goods or services from initial development and production through disposal.

For any good or service, a multitude of components and processes are involved in the manufacture, use and/or disposal of the good and/or service (e.g., article of clothing or energy supply service). For example, for a given article of clothing, raw materials such as cotton or synthetic fibers must be grown or manufactured; the raw materials must be developed into one or more intermediate manufacturing components, for example, yarn or thread; the intermediate manufacturing components must be transformed into components of the example article, for example, shirt sleeves, the components of the article must be assembled into a final version of the article, and the article likely must be stored or warehoused, transported, displayed, sold, used, recycled, reused, and ultimately disposed of after the useful life of the article has expired.

At each step along such an example process, energy is utilized, raw materials are grown, harvested and used, manufacturing processes are utilized (which may entail the use of secondary products, water and power), and ultimately one or more disposal methods are employed (which may include recycling and reuse). At each such process step or phase, materials that are used, energy that is consumed, processes that are employed may have a variety of environmental and social impacts. For example, a variety of energy sources may be used in the production of a good, each of which may have differing environmental impacts. For example, solar or hydroelectric power may have one environmental impact, fossil fuel-based energy may have another environmental impact, nuclear-based energy may have another environmental impact, and the like. For another example, one type of manufacturing process may be very labor-intensive, and another type of manufacturing process that results in the same product may be performed with a small amount of human labor, but may nonetheless use large amounts of expended energy, for example, in the case of mechanized manufacturing versus hand manufacturing.

According to embodiments, life cycle inventory (LCI) data associated with each component or process involved in the manufacture, use and disposal of a good, or in the development and provision of a service may be collected for ultimately developing a life cycle assessment (LCA) for a given good or service to allow persons or entities engaged in the development, manufacture, distribution, use or disposal of goods or services to operate in an informative manner with respect to the life cycle of the goods or services. According to embodiments, each supplier of a good or service or each supplier of a component of a good or service (hereinafter collectively referred to as “product”) for which LCI data is desired or required provides a unit process data set for their respective products. The unit process data set includes data on all components or processes utilized by the supplier in the manufacturing, development, delivery, use or disposal of their respective products, including, energy, raw materials, processing methods, components of and information about use, components of and information about disposal, and the like.

Providing unit process data for a given product may be performed according to a variety of methods. First cradle-to-gate or cradle-to-grave life cycle inventory data may be provided via a structured data template for organizing the data according to a prescribed structure required for processing the data. Second, the LCI data may be provided as raw data via a generic unit process model requested by the data supplier. Alternatively, a combination of structured data and raw data may be provided by a given supplier.

As will be described below, data provided by a given supplier may be passed through a distributed computing network, for example, the Internet or an intranet, to a life cycle inventory and assessment data hub where the data may be validated and/or audited, and where the data may be aggregated and scored in terms of its environmental and/or social impact with reference to the product for which the data is collected. The environmental and/or social scoring may be used by consumers of the product in determining the environmental and/or social impact associated with their consumption of the product whether their consumption is end use, or whether their consumption is involved in using the product in the development, manufacturing, use and/or disposal of one or more other goods and/or services.

For purposes of illustration, one or more examples will be described below. While a given example may apply more to environmental impact, such as the use of water, fuels, and chemicals, social impact is equally important where the social impact of the creation and/or use of a product may be of substantial importance. For example, if a given product is manufactured under inappropriate labor standards, such information may be quite useful in scoring a given product and in providing such information to potential consumers of the product.

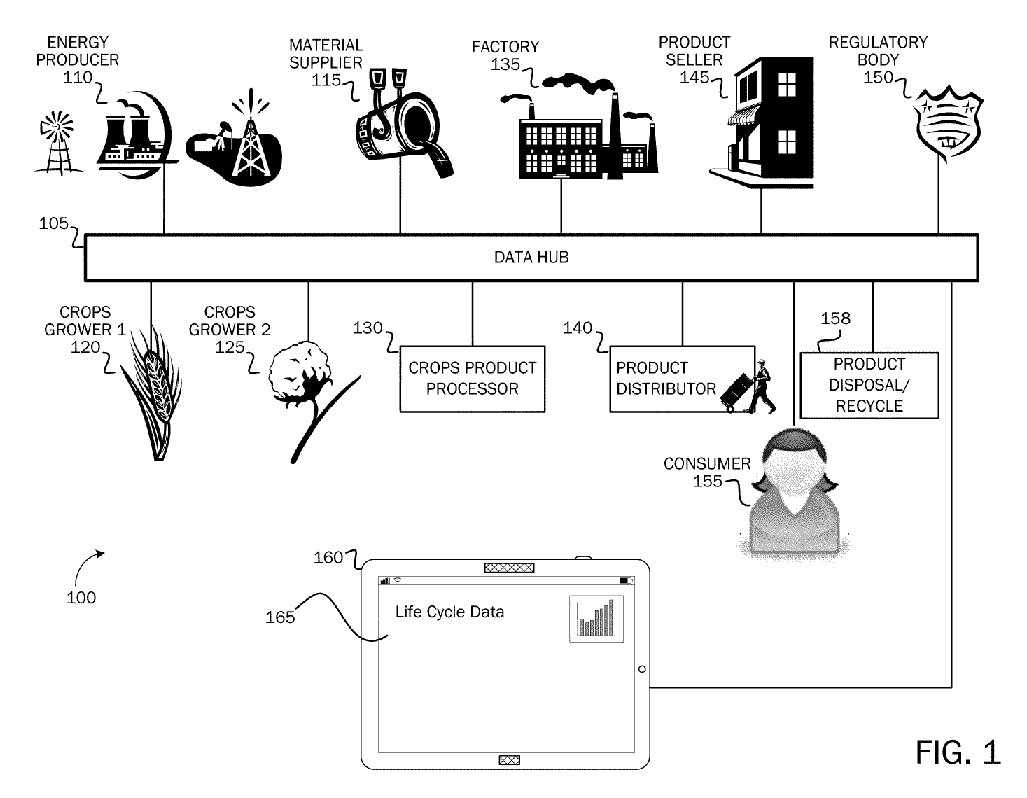

FIG. 1 is a simplified block diagram illustrating a life cycle of one or more goods and/or services from production through consumption. The components and processes illustrated in FIG. 1 are illustrative of a variety of suppliers of one or more products where such products may be in the form of components and/or services provided for and/or utilized in association with the development, production, use and/or disposal of one or more products. For example, referring to FIG. 1, an energy producer 110 is illustrative of a fossil fuels-based energy production provider, a solar or hydroelectric power energy provider, a nuclear-based energy provider, and the like. A material supplier 115 is illustrative of a manufacturer or supplier of a variety of materials, for example, raw materials, chemicals, natural and human-made materials, equipment, and the like. For example, the material supplier 115 may be a supplier of fertilizers or pesticides used in the production of crops. Likewise, the material supplier 115 may be a supplier of an intermediate component, for example, a manufactured component that it used in some other product or service.

The crop grower 120 and the crop grower 125 may be illustrative of one or more suppliers of natural materials, for example, crops, timber, mined ores, and the like. The crops product processor 130 is illustrative of a factory or processing unit responsible for transforming a raw material from one state to another. For example, the crops product processor 130 may be a manufacturing concern operative to transform raw cotton into cotton yarn or thread that may be utilized in the production of an article of clothing. The factory 135 is illustrative of a factory for processing one or more supplied materials into a useful intermediate or end-user product. The product distributor 140 is illustrative of one or more distribution systems, transportation systems, communication systems, warehousing or storage systems, involved in the processing, storage, delivery and/or utilization of one or more products.

The product seller 145 is illustrative of any organization operative to sell one or more intermediate or end-user products. A regulatory body 150 is illustrative of any organization tasked with overseeing, managing or regulating the development, manufacture, use or disposal of a product. A consumer 155 is illustrative of any intermediate user or end user of a product. For example, any of the entities 110-150 may indeed be a consumer of products, as described herein.

The disposal/recycle unit 158 is illustrative of a number of processes that may be applied to a given product at the end of its useful life. For example, a product may be disposed of in a landfill or other disposal site, a product may be incinerated, and the like. All of such disposal methods may be associated with a number of environmental and social impacts. In addition, the disposal/recycle unit 158 may be illustrative of recycling processes or reuse processes where products or components of products may be recycled for subsequent use or where products may be reused in their current or altered forms.

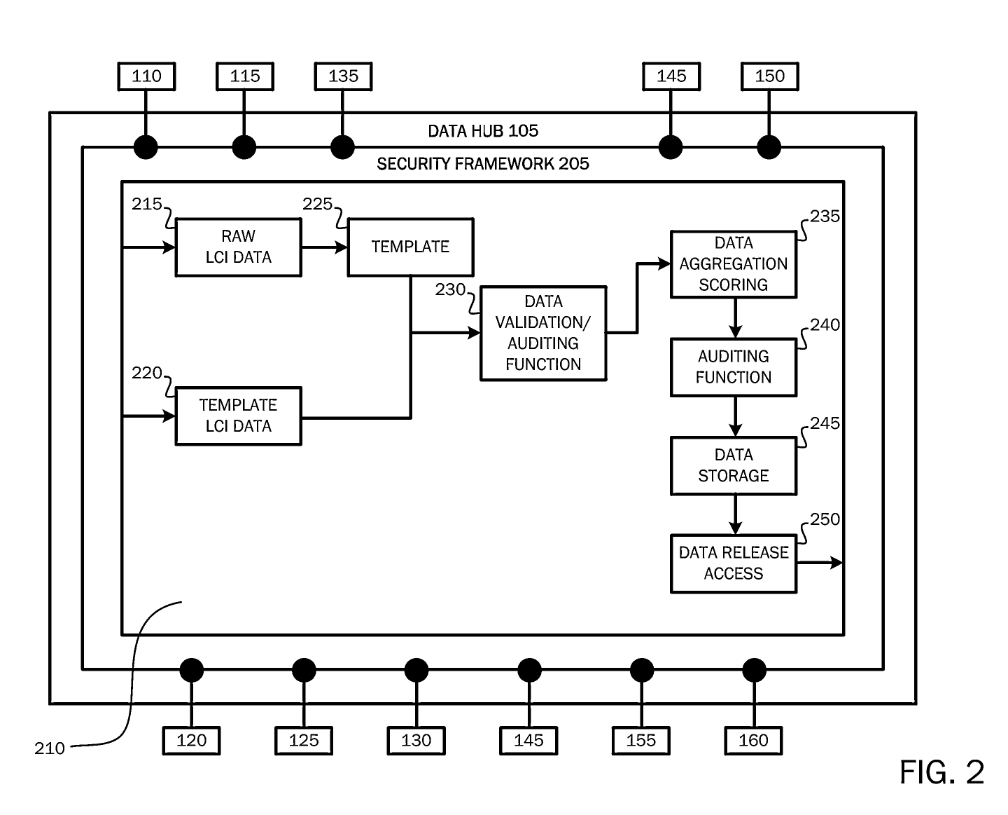

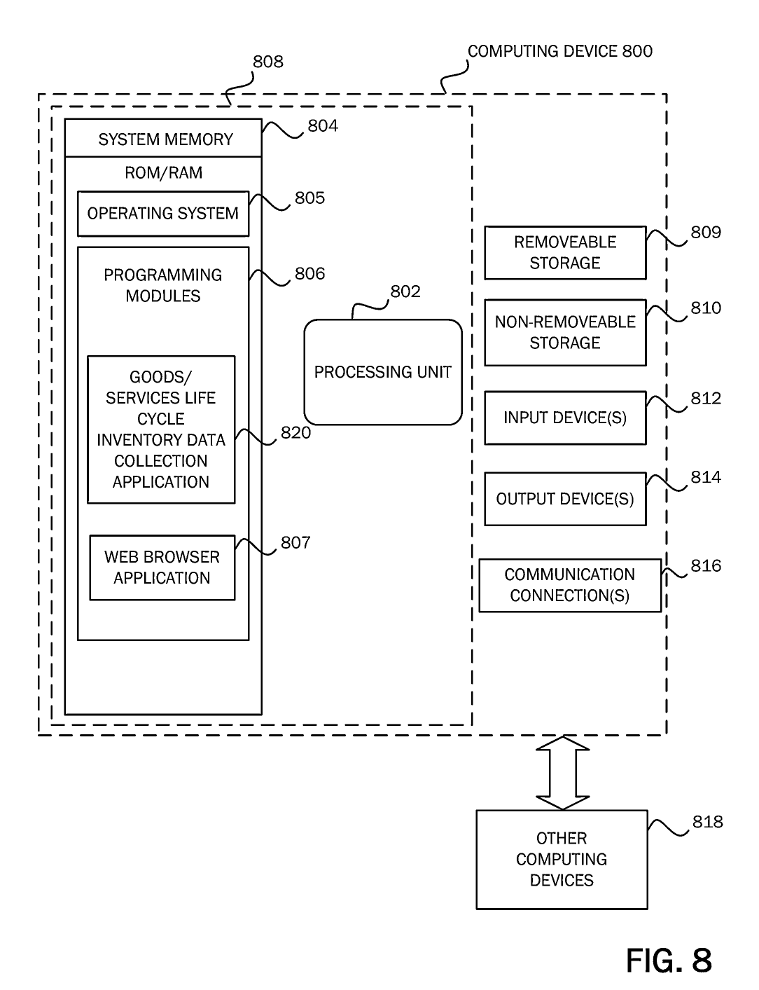

As will be described below with reference to FIG. 2, the life cycle inventory and assessment data hub 105 is illustrative of one or more computing components and data repositories to which life cycle inventory data may be passed for organization, validation and/or auditing, aggregation, storage, and release to one or more users of the life cycle inventory data. The computing device 160 is illustrative of any computing device, described below with reference to FIGS. 8, 9A, 9B and 10 with which life cycle inventory and life cycle assessment data may be presented, processed, accessed and released, as described herein. The display screen 165 on the computing device 160 is illustrative of a computer-enabled display screen on which may be displayed one or more life cycle inventory and/or life cycle assessment data items, as described herein.

According to embodiments, each of the components of the system architecture illustrated in FIG. 1 may operate as standalone components that are operatively connected with the data hub 105 for providing and receiving life cycle inventory and life cycle assessment data in association with their respective products. That is, each of the supplier entities 110-155 may be independent operating entities located at disparate locations around the world and that are operative for providing their respective products as intermediate or end-user products. The data hub 105, and its components, described below with reference to FIG. 2, may operate as a collection of computing devices and data storage repositories at a single location, or the components of the data hub 105 may be operated as a distributed computing network where one or more of the components of the data hub 105 may be located at disparate locations relative to other components of the data hub 105, all of which may be connected via a distributed computing network, such as the Internet or an intranet.

As will be described herein, each supplier in a given product life cycle may submit life cycle inventory data on his/her products through the data hub 105, and the life cycle inventory data for all products associated with or combined as part of the life cycle of a given product may be aggregated for a scoring of individual products and for ultimate products into which individual products are combined or with which individual products are utilized. For example, consider that the suppliers illustrated in FIG. 1 are associated with the manufacturing of a shirt or other article of clothing. According to an embodiment, the energy producer 110 may provide life cycle inventory data associated with all components required for the production of energy, a crop grower 120, 125 may provide life cycle inventory data associated with all aspects of crops production, for example, fertilizers, pesticides, fuels, labor, and the like associated with growing cotton, the factory 135 may supply data associated with manufacturing processes required for transforming cotton thread or yarn into fabric with which a shirt or other article of clothing may be made, the distributor 140 may submit life cycle inventory data associated with all aspects of distribution of a manufactured shirt or other article of clothing, for example, fuel types and usage data, warehousing capacities, utilization, heating and cooling statistics, and so on.

According to embodiments, the life cycle inventory data submitted by each supplier may be used for generating an environmental and/or social impact score for that product, and ultimately the environmental and/or social impact scores associated with each intermediate component, for example, energy, crops production, manufacturing, storage, distribution, and the like, may be aggregated together to generate an environmental and/or social impact score for an end product, for example, a shirt or other article of clothing. The environmental scoring generated from the life cycle inventory data provided by each supplier may then be used by each supplier to determine which intermediate component the supplier desires to use in their products. Downstream users of an end-user product may utilize the life cycle assessment scoring generated from the life cycle inventory data provided by each supplier to determine whether the users desire to use a given product as opposed to another product based on the life cycle assessment storing for two competing products.

Referring now to FIG. 2, one or more components and/or systems comprising and interacting with the life cycle inventory (LCI) and life cycle assessment (LCA) data hub 105 are illustrated and described. As described above, the data hub 105 includes a number of computing systems and/or data storage repositories operative to receive and process life cycle inventory data associated with a variety of intermediate and/or end-user products including information about components and/or processes involved in the development, manufacture, use and disposal of one or more intermediate or end-user products.

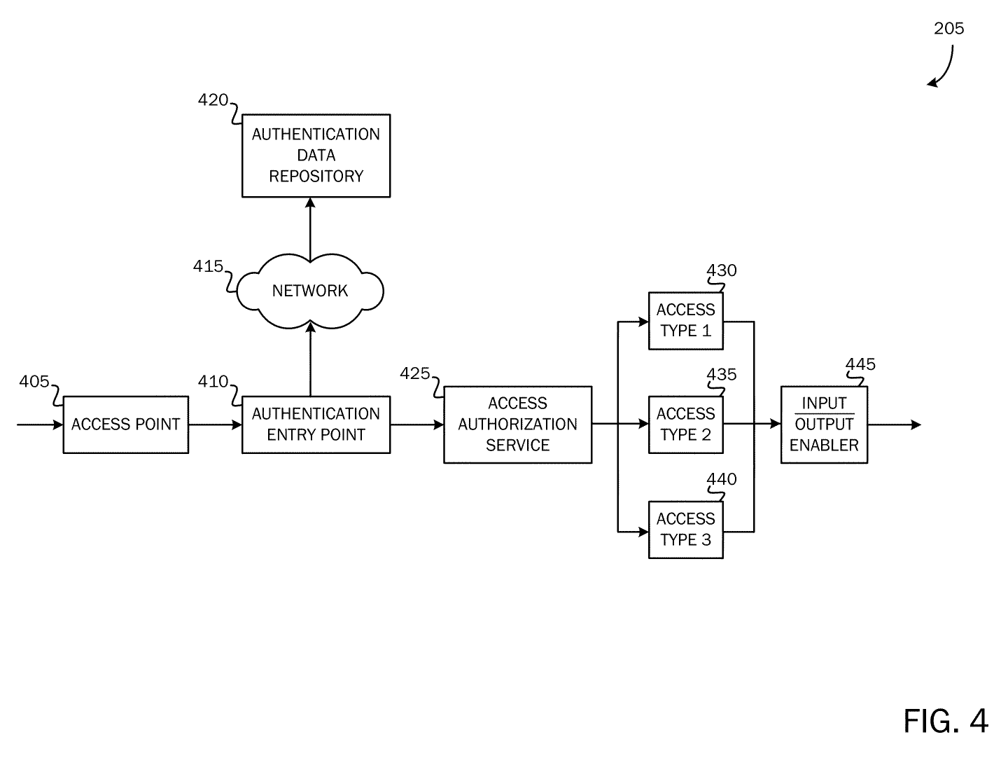

A security framework 205, described below with reference to FIG. 4, is operatively positioned between suppliers 110-155 and the data hub 105 in order to provide secure access to the data hub 105 and in order to prevent unauthorized or unsecured access to the data hub 105. As should be appreciated, life cycle inventory and life cycle assessment information for various products (both intermediate and end-user products) may be highly sensitive information having a great impact on the competitive positions of one supplier versus another supplier, and consequently, information obtained from various suppliers must be secured from access by other suppliers to allow suppliers the comfort of knowing they can provide life cycle inventory information on their products and services without being concerned that that information may be exposed to other suppliers which may allow other suppliers to be aware of competitive advantages/disadvantages associated with their products. Such concerns on the part of a given supplier of LCI and LCA information may discourage or prevent the sharing of valuable life cycle inventory information, as described herein, if the sharing of such information cannot be done in a secure manner.

According to embodiments, an individual supplier 110-155 may submit life cycle inventory data, for example, fuel usage, energy usage, raw material usage, raw material processing data, transportation information, and the like, through a variety of means. According to one method, a supplier may submit raw business or business transaction data 215 to the data hub 105 for automated processing by the data hub 105. As used herein, raw business or business transaction data may include any data a supplier may have on processes or materials used by the supplier in the manufacture or use of a given product, but for which the supplier cannot provide life cycle inventory data in a structured manner, as will be described herein. Examples of such raw business or business transaction data include purchase data, sales data, amounts of processes or materials used, and the like. As described herein, such raw business and business transaction data ultimately may be converted into LCI data. For example, if the supplier lacks equipment, personnel, or otherwise, lacks the technical sophistication for presenting life cycle inventory in a structured manner, as described below, raw business or business transaction data may be presented by the supplier. For example, if the crops grower supplier 120 is in the business of growing cotton for use in the manufacture of clothing items, the crops grower may not have equipment, personnel, or access to technical means for presenting his/her life cycle inventory data in a structured manner, as described below. Thus, the crops grower may submit raw business or business transaction data 215, such as gallons of fuels used, tons of fertilizers used, and the like, to the data hub 105.

For the example crops grower, such raw business or business transaction data may include amounts and types of fuel usage for farming equipment, amounts and types of fertilizers and pesticides used, amounts of labor used, including, information about labor-providing personnel, amounts of crops produced, durations of crops production, and the like. If the supplier has additional information about each life cycle inventory data item, for example, material safety data sheets associated with chemicals, for example, pesticides and fertilizers, brand names associated with fuels or other energy sources, purchase orders providing data associated with various raw materials used in the supplier's processes, and the like, such information may be provided with the raw business or business transaction data for assisting in structuring, validating and auditing the information received from the supplier.

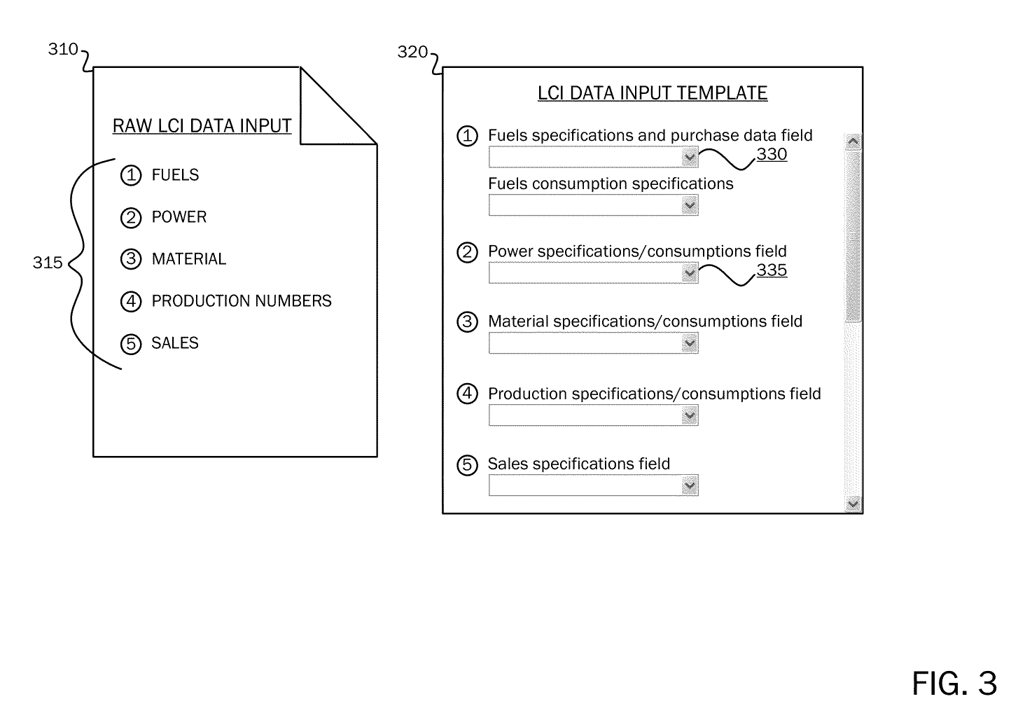

If raw business or business transaction data is provided by a supplier, the received data may be automatically populated into a template 225 received via a generic unit process model, as described below with reference to FIG. 3, for providing data structuring to each received data item so that structured data items received by the supplier may be used by one or more computing processes described herein for validating and auditing the information, for aggregating and scoring the information, and for ultimately storing and releasing the information to other requesting suppliers.

According to one embodiment, such a supplier desiring to submit raw business or business transaction data may request via the data hub 105 a generic unit process model from the data hub 105 to allow the supplier to provide raw business or business transaction data. Such a model provided by the data hub 105 may be based on a product category rule (PCR) that applies to the supplier's product. For example, if the supplier's product is raw cotton, then a data model based on a product category rule applied to other suppliers of raw cotton may be presented to the supplier to assist the supplier in providing the raw business or business transaction data in a manner such that the data may ultimately be structured via the template 225 for use by the processing components of the data hub 105.

The product category rule-based model may be defined by one or more standards bodies, for example, the International Organization for Standardization (ISO). The product category rule-based model may be utilized and may be provided by comparing the finished products categorization (e.g., finished product being raw cotton, or finished product being one or more end products including raw cotton) with that of the product category rule to be applied to the example raw cotton. Once the supplier receives the unit process model, the supplier may then complete a template associated with unit process model with required information. For example, a unit process model for the production of raw cotton may provide a template 225 having fields to allow a supplier to enter data, as described above, such as fuel types and usages, pesticide and fertilizer types and usages, labor usage, production quantities, production durations, and the like. The data provided via the unit process model may include, but is not limited to, purchase orders, invoices, sales information, production locations, vendor information, customer information, descriptions of technologies used, and the like. Such information may allow for validation and auditing and ultimate scoring of the data, for example, where a technology used by one supplier has a greater environmental or social impact than a technology used by another supplier. For example, the use of human labor versus the use of mechanized production may impact both the environmental and social scorings applied to a given product. Use of the unit process model may allow for the data provided by the supplier to be compared with other similarly situated or types of data to allow for data validation and auditing via the data hub 105.

Alternatively, referring still to the data hub 105, a given supplier 110-155 may provide life cycle inventory data in a structured manner via a template 220 with which the supplier submits complete life cycle inventory data that the supplier collects, annotates, and organizes using one or more business data systems, direct measurement, databases, and research. For example, if a supplier is a highly sophisticated organization in the business of manufacturing a chemical that may be a down range component or constituent of an end-user product, such a supplier may possess or be associated with laboratories, accounting functions, manufacturing and data measurement functions, and the like to allow the supplier to collect detailed life cycle inventory data and to organize the collected data into one or more sets of collected data for provision to the data hub 105 via a template 220. For example, such a supplier may be fully capable of measuring and documenting energy consumption associated with the production of a given product or component, the supplier may be capable of assembling accounting data associated with labor statistics involved in the production of a given product, and the like.

As described above, any given supplier may provide life cycle inventory data to the data hub 105 either as raw business or business transaction data, or as structured life cycle inventory data. Alternatively, a given supplier may provide life cycle inventory data to the data hub 105 in a combination of these two data provision methods. That is, a given supplier may possess sophisticated and detailed life cycle inventory data generated via its own processes or via its own ability to obtain such data, but such a supplier may also utilize one or more intermediate or end-user products in its processes for which it does not have such detailed life cycle inventory data. In such a case, the supplier may present structured life cycle inventory data via a template 220 for products for which it possesses such data, and the supplier may present raw business or business transaction data 215 via a unit process model template 225 for any intermediate or end-user products the supplier utilizes for which it does not have detailed life cycle inventory data.

Referring still to FIG. 2, once life cycle inventory data is received from a given supplier, the data may be passed through a data validation and auditing function 230. The data validation function 230 may validate data received by a given supplier to determine whether the information received by the supplier is correct for the type of information received. For example, if a supplier provides information that it has utilized a certain number of metric tons of hydroelectric power where hydroelectric power is utilized in terms of kilowatt-hours as opposed to metric tons, the validation function may notify the supplier and ultimately may reject the data if the supplier does not correct the information it has provided. As should be appreciated, other types of validation may be performed, for example, where information provided by a supplier for a given intermediate or end-user product includes component specifications not recognized in comparison to any other similar products.

The auditing function 230 may compare received data against other similar types of data to determine whether the received data appears to be accurate in comparison with other similar types of data. For example, if a given supplier presents life cycle inventory data for a pesticide showing that the pesticide has certain toxicity levels beneath a desired threshold for toxicity, the data auditing function 230 may compare that information with toxicity levels known for other pesticides of the same pesticide type, for example, pesticides having the same or similar chemical make-ups and/or structures. If the information provided by the supplier, for example, the toxicity levels for a given pesticide, is out of range with other similarly utilized products, the auditing function 230 may notify the providing supplier and may reject the information.

After life cycle inventory data is received, validated, and audited, the data may be aggregated and scored for a given product by the data aggregation and scoring function 235. That is, a score associated with an environmental and/or social impact for the given product may be generated for presentation to requesting suppliers who may desire to use a product as an intermediate or end-user product. For example, if an environmental impact scoring system rates environmental impact of a given product on a range from zero to 100, and if a given product receives an environmental impact score of 60, a consumer of the product may choose another product receiving a higher environmental impact score. For more information on the aggregation and scoring of received and collected life cycle inventory data, see United States Patent Application, titled “Aggregation of Life Cycle Impact Assessment Data for Generation of Life Cycle Impact Assessments and Scoring,” Ser. No. 13/228,327, Attorney Docket No. 14917.1520US01/329507.01, filed Sep. 8, 2011, which is incorporated herein by reference as if fully set out herein.

After life cycle inventory data is aggregated and scored, the data may be passed through another auditing function 240 for comparing life cycle assessment scoring for the associated product with other similarly situated or types of products. The life cycle assessment scoring information may be stored in a storage repository 245, and ultimately the life cycle assessment information may be released through a release access point 250. According to an embodiment, the data release access point 250 may allow suppliers to obtain life cycle inventory data and life cycle assessment data for one or more products by accessing the data hub 105 via the secure framework 205.

As should be appreciated, in addition to life cycle assessment scoring generated for one or more life cycle inventory items, suppliers may request life cycle inventory data that has been received from other suppliers and that has passed through the data validation and auditing function 230. That is, before life cycle inventory data is aggregated and scored, or apart from aggregation and scoring, one or more other suppliers may request and receive life cycle inventory (LCI) data for one or more products. For example, the second crops grower 125 may request through the secure framework 205 life cycle inventory data provided by the first crops grower 120 to assist the second crops grower 125 in modifying its crops growing processes to include a modification of the life cycle inventory components or processes it uses.

As described below, release of such LCI data from one particular supplier to another supplier may present business, security or competition risks to the releasing supplier. Thus, according one embodiment, requested LCI data may be provided to a requesting supplier 125 in aggregate as a mean and median for comparative purposes without explicit authorization (other than being in the data hub to begin with), provided the data hub has sufficient aggregation of data to make data anonymous. For example, if the second crops grower desires LCI data for fuel usage by other similar crops growers, the requesting supplier may be provided with an average LCI data for fuel usage across a number of similar crops growing operations.

If the data hub has access to only one data point, and provision of a mean or median or other statistically significant data type for the requested information is not available, then provision of the requested data may be restricted. For example,

If certain information provided by a given supplier, e.g., the first crops grower 120, is proprietary in nature, for example, a proprietary combination of one or more intermediate products used in the production of an end-user product, then such information may be secured from access by another supplier. According to embodiments, a given supplier may indicate that certain life cycle inventory information is proprietary, and upon approval by the data hub 105, such life cycle inventory information may not be released to other requesting suppliers. For example, if a certain combination of components is proprietary in nature, the combination of the components may not be released to other requesting suppliers, but information on individual components may be released to requesting suppliers.

As described above, suppliers may provide life cycle inventory data either as raw business or business transaction data in association with a unit process model, or suppliers may provide detailed life cycle inventory data according to a structured data template for use by the data hub 105. Referring to FIG. 3, the raw LCI data input document 310 may include a document of various types, for example, a word processing document or spreadsheet application document, with which a supplier may provide life cycle inventory information associated with a given product. For example, data 315 may be provided such as fuels data, power type and consumption data, materials data, production numbers, for example, bales of cotton produced during a given period, sales information, and the like. According to embodiments, a certain degree of data structuring may be required for the raw LCI data input document 310 in order for the associated data to be transformed by the data hub. For example, data headings or data metadata applied to various provided data points may be required to allow use of the data by the data hub 105, as described herein.

As described above, the raw business or business transaction data may be provided to the data hub 105 by a given supplier if the given supplier lacks the ability to provide the data in any structured manner, or according to a requested unit process model. Raw business or business transaction data received via a document 310 may then be automatically parsed and inserted into appropriate fields of a unit process model template or life cycle inventory data input template 320, described below.

The template 320 is illustrative of a template with which a supplier may provide detailed life cycle inventory information where such information is available to the supplier. According to one embodiment, the template 320 may be obtained via a unit process model requested by a supplier and may contain fields for entering specific information about life cycle inventory data, for example, specific information about fuel types and usage, power usage specifications and consumption rates, materials and components information, production specifications, sales specifications, and the like. Thus, a supplier who has the ability to provide detailed LCI data may utilize the template 320 without the need for requesting a unit process model for providing LCI data to the data hub 105.

Referring now to FIG. 4, as described above, a security framework 205 may be operated between suppliers and the data hub 105 and between one supplier and another supplier to secure data provided to and received from the data hub 105 from unauthorized access. The system architecture illustrated in FIG. 4 is one example of a security framework system architecture, but is not limiting of a vast number of security frameworks that may be employed for securing access to data provided to and retrieved from the data hub 105.

An access point 405 is illustrative of one or more access points with which a supplier may gain access to the data hub 105. According to one embodiment, the access point 405 may operate as a web services platform through which a supplier may access the data hub 105 through an Internet-based web page. The access point 405 likewise may operate according to a variety of other telecommunications-based access points to allow a supplier computing device to obtain access to the computing devices and/or storage repositories of the data hub 105.

An authentication entry point 410 is illustrative of a software application module operative to obtain authentication information from a supplier and to pass the authentication information to an authentication data repository 420 via a distributed computing network 410 or to a local authentication data repository 420 for obtaining authentication information. For example, the authentication entry point 410 may provide a dialog box to a requesting supplier requiring that a requesting supplier enter a password or other authenticating information for determining whether the requesting supplier may have access to data contained in the data hub 105. Once the authentication entry point 410 receives requested authentication information from the supplier, the authentication entry point may obtain authentication information for the requesting supplier from the authentication data repository 420. The access authorization service 425 may compare information received by the requesting supplier with information stored for the requesting supplier to determine whether the requesting supplier may have access to the computing systems and data of the data hub 105.

If the requesting supplier is granted an access privilege for access to the data hub 105, one or more access types 430, 435, 440 may be granted to the requesting supplier. For example, a first access type 430 may allow the supplier to provide LCI data and to request and receive LCI data associated with its own products only. A second access type 435 may allow the supplier to enter or provide LCI data and may allow the supplier to request LCI data for its own products as well as for a specified group of other products. A third access type 440 may specify a limited access by a requesting supplier of certain types of data, but may specify certain other types of data to which the supplier may not obtain access. For example, as described above, certain information contained and processed by the data hub 105 may include proprietary information, for example, specific combinations of components used by another supplier for achieving a desired result. The access authentication service 425 may grant an access type to a requesting supplier that restricts the requesting supplier from such proprietary data. The input/output enabler 445 is a software application operative to allow the requesting supplier to input LCI data and to receive LCI data in accordance with the access type granted to the requesting supplier.

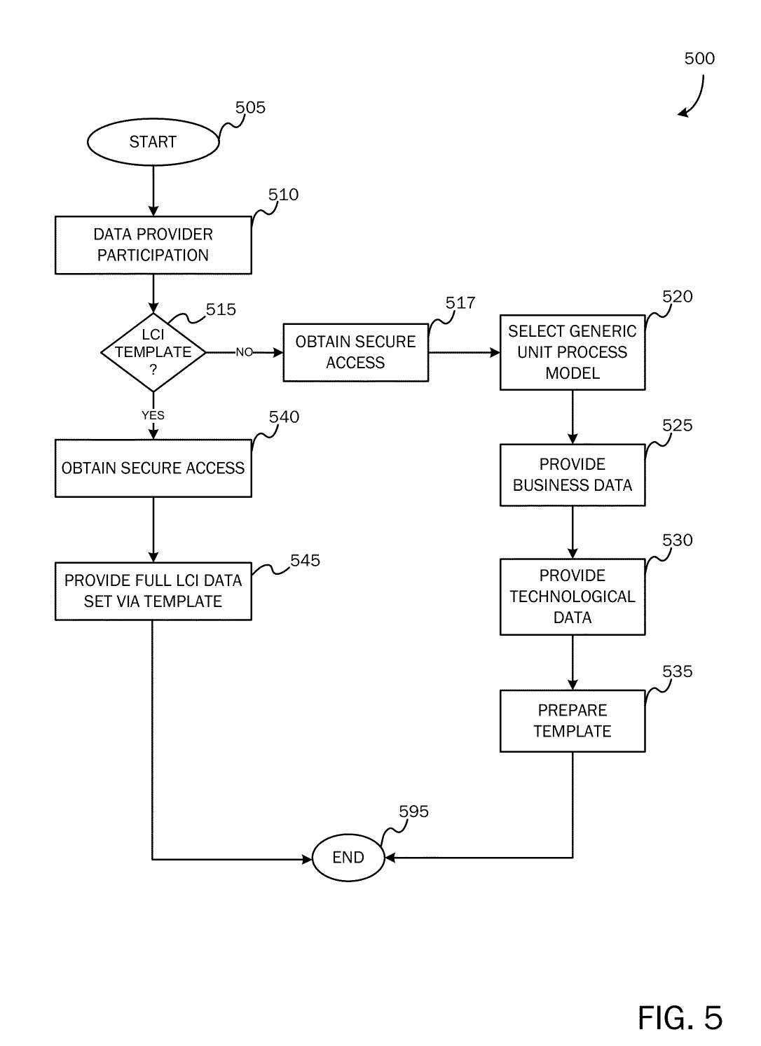

As described above, LCI data may be entered by a variety of suppliers for providing LCI data associated with components and/or processes for a given product developed, manufactured, used or disposed of by the supplier. FIG. 5 is a flow chart illustrating a method of receiving life cycle inventory data. The routine 500 begins at start operation 505 and proceeds to operation 510 where a given data provider, for example, a product supplier, decides to participate in a life cycle inventory and life cycle assessment program for entering life cycle inventory data for one or more products. As should be appreciated, unless the participation of a particular supplier in the life cycle inventory/life cycle assessment program is required by a regulatory or other governing body or agency, for example, as might be the case if a product is a drug or other pharmaceutical-based product, then at operation 510, a given supplier may opt out of providing life cycle inventory data.

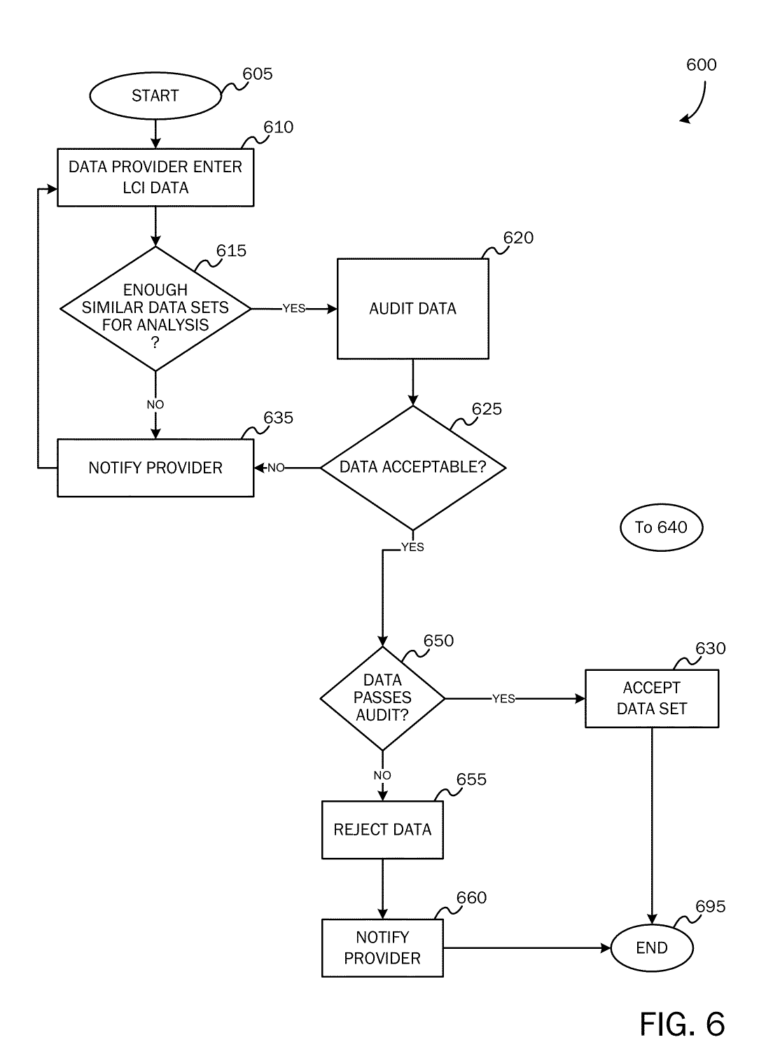

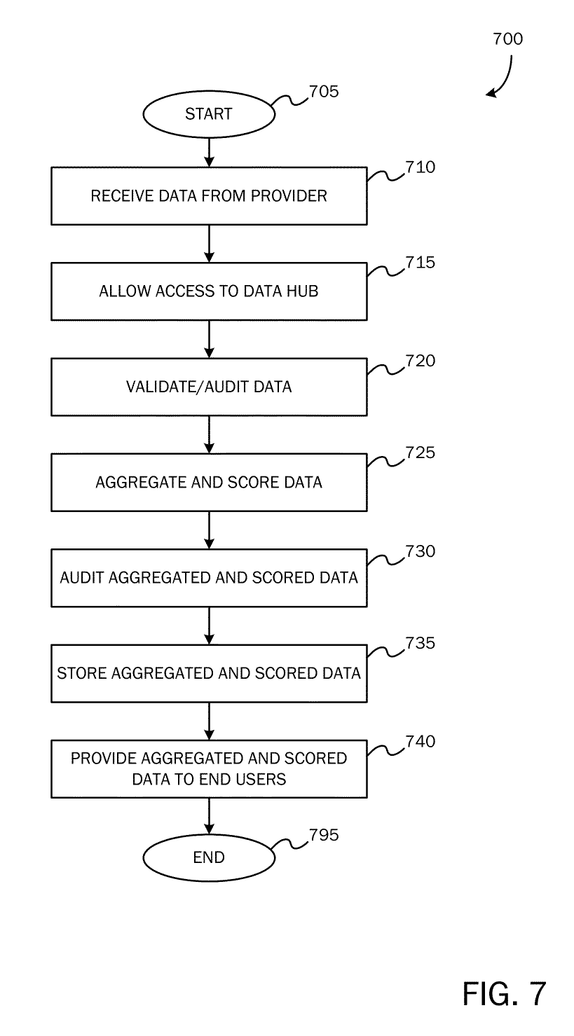

If a given supplier does desire to participate in a life cycle inventory/life cycle assessment program, the routine proceeds to decision operation 515, where a determination is made as to whether the participating supplier may provide life cycle inventory data as raw LCI data or whether the supplier may provide structured LCI data via a data template 320 as described above with reference to FIG. 3. If the supplier is able to submit LCI data via a structured data template 320 containing sufficient detailed product and/or business information, the routine may proceed to operation 540 where the participating supplier gains access to the data hub 105 via the security framework 205. At operation 545, a full set of LCI data is provided by the supplier for one or more products via the template 320. The structured data provided by the supplier via the template 320 may then be processed by the data hub 105, as described below with reference to FIGS. 6 and 7.

Referring back to operation 515, if the supplier of LCI data lacks the ability to provide the full LCI data set via the template 320, the routine proceeds to operation 517, and the data providing supplier obtains access to the data hub 105 via the security framework 205, described above. At operation 520, the supplier selects a generic unit process model from a list of provided process models associated with the supplier's products. For example, if the supplier is engaged in providing a crop product, for example, cotton for use in manufacturing articles of clothing, a generic unit process model associated with crops produced for manufacturing articles of clothing may be selected by the supplier for providing required LCI data. That is, as should be appreciated, once a given supplier gains access to the data hub 105, a user interface may be presented to the supplier to allow the supplier to select from a variety of unit process models that is most applicable to the product provided by the supplier and with which the supplier may obtain a template 320 for entering information about its product.

At operation 525, business data is provided by the supplier, for example, sales information, production information, labor statistics, material usage, energy usage, and the like. At operation 530, technological data utilized by the supplier may be entered to include uses of mechanized production facilities, uses of computerized and software-driven processing, and the like. At operation 535, the template 320, illustrated above, may be prepared by the supplier via the generic unit process model requested by the supplier, and the information provided via the template 320 may be processed at the data hub 105, as described below with reference to FIGS. 6 and 7. As described above, a given supplier may provide LCI data as both raw data through a requested unit business model and as full LCI data sets through one or more templates 320.

As described above, after LCI data is provided to the data hub 105 as either raw data or as structured data, the data hub 105 may validate and audit the received data to determine whether the received data may be utilized in a data aggregation and scoring process, described above. FIG. 6 is a flow chart illustrating a method of validating life cycle inventory input from one or more data providers. The routine 600 begins at start operation 605 and proceeds to operation 610 where LCI data provided by a supplier is received, as described above with reference to FIG. 5.

At operation 615, the data validation/auditing function 230 compares the received LCI data to determine whether the data sets received by the supplier contain sufficient information for a validation and auditing analysis of the received data. For example, if a supplier provided LCI data via a structured template 320, as described above, the auditing function 230 may review the received data and compare the received data to similarly received data sets to determine whether enough data has been presented to allow for further use and analysis of the received data. For example, if a template 320 is received with a single completed field, and no other data, a determination may be made that an insufficient amount or type of data has been received to allow for further analysis, and the routine may proceed to operation 635. At operation 635, the supplier may be notified that provided data is insufficient or inappropriate, and the routine may proceed back to operation 610 where the supplier may be allowed to submit new or additional data.

If a determination is made that enough and appropriate types of information have been received via the template 320, for example, where each required data field has been completed with information complying with the requirements of the data field, the routine may proceed to operation 620 where the information may be audited by comparing the information to data provided by other suppliers according to similar processes. For example, if the LCI data received is associated with crop production for the manufacture of articles of clothing, the LCI data received by the supplier may be compared with LCI data provided by other suppliers of crops data in association with the production of articles of clothing.

At decision operation 625, if a significant deviation exists between the received LCI data and other similar product/process LCI data, the routine may proceed to operation 635, as described below. As should be appreciated, this process may give the supplier a degree of knowledge of the aggregate data maintained in the data hub 105, depending on the threshold level being considered as a norm for any given product/process. For example, if a supplier knows that a notification that a certain data fails the audit function when the data submitted are off by +/−10% of the mean, then the supplier may be able to determine the mean by submitting data outside of that threshold. If the ability to gain such information is restricted, then the notification provided to the supplier, as described below for operation 635, may have to be tailored to prevent suppliers from determining the example mean threshold.

As should be appreciated, deviation thresholds may be set for various types of products or components of products to aid in the analysis of whether received data does or does not deviate significantly from similar product/process LCI data. For example, toxicity levels associated with a given pesticide or fertilizer may exist in a certain range of toxicity levels for pesticides or fertilizers used in similar processes. If LCI data for a pesticide or fertilizer product is received showing a toxicity level outside the range of normal toxicity levels, then a determination may be made that the data deviates too significantly from similar data for similar products/processes, and the routine may proceed to operation 635, as described below. At decision operation 625, if no significant deviation between the received LCI data and similar product/process LCI data is presented, the routine may proceed to operation 630 where the received data set is accepted for use in data aggregation and scoring for life cycle assessment generation.

Referring now to operation 635, if the received data fails the validation operation, described above, or if the LCI data received deviates significantly from similar LCI data for similar products/processes, the routine proceeds to operation 635. At operation 635, the supplier/provider of LCI data may be automatically notified that the data received is insufficient, invalid, or is otherwise not acceptable to the data hub 105. According to one embodiment, an automatic notification may be passed to the supplier/data provider to indicate those aspects of the received data that must be corrected or enhanced. For example, if a supplier provides usage data for hydroelectric power usage in terms of metric tons of usage as opposed to in terms of kilowatt-hours of usage, a notification may be provided to the supplier to correct the usage terms and to resubmit the LCI data.

At operation 650, if the auditing function 230 determines the life cycle inventory data received from the supplier is acceptable, the routine proceeds back to operation 630 and the received LCI data is accepted for use in generating a life cycle assessment from the data, as described below.

If the received LCI data is not acceptable, the routine proceeds to operation 655 and the received LCI data is rejected. At operation 660, the supplier may receive a notification that the LCI data has been rejected to allow the supplier to update or otherwise enhance the provided LCI data. The routine ends at operation 695.

Having described a system architecture and methods for receiving, validating and auditing life cycle inventory data, FIG. 7 is a flow chart illustrating a method of processing received life cycle inventory data. The routine 700 begins at start operation 705 and proceeds to operation 710 where life cycle inventory data is received from a data provider or supplier of one or more products or processes. At operation 715, access by the supplier is provided via the security framework 205.

At operation 720, life cycle inventory data is provided by the supplier, as described above, and the provided LCI data is validated and/or audited to determine whether the data is valid and accurate for use in generating a life cycle assessment. At operation 725, the life cycle inventory data is aggregated with other life cycle inventory data associated with a given product or process, and a life cycle assessment score is generated for the given product or process.

At operation 720, the aggregated life cycle inventory data and life cycle assessment score is audited to determine whether the LCA score for the aggregated data is proper in comparison to life cycle assessments generated for other similar products or processes. At operation 735, the aggregated life cycle inventory data and LCA score are stored. At operation 740, the aggregated life cycle inventory data and/or life cycle assessment scoring data may be provided to one or more end users for use in association with downstream intermediate products or downstream end-user products, as desired. The routine ends at operation 795.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 8-10 and the associated descriptions provide a discussion of a variety of operating environments in which embodiments of the invention may be practiced. However, the devices and systems illustrated and discussed with respect to FIGS. 8-10 are for purposes of example and illustration and are not limiting of a vast number of computing device configurations that may be utilized for practicing embodiments of the invention, described herein.

FIG. 8 is a block diagram illustrating example physical components of a computing device 800 with which embodiments of the invention may be practiced. The computing device components described below may be suitable for the computing devices described above, for example, the computing device 160. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination. System memory 804 may include operating system 805, one or more programming modules 806, and may include the comments application 820. Operating system 805, for example, may be suitable for controlling computing device 800's operation. Furthermore, embodiments of the invention may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810.

As stated above, a number of program modules and data files may be stored in system memory 804, including operating system 805. While executing on processing unit 802, programming modules 806, such as the life cycle inventory and assessment application 820 may perform processes including, for example, one or more of the stages of methods 500, 600 and/or 700. The aforementioned process is an example, and processing unit 802 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the life cycle inventory and assessment application 820 may be operated via application-specific logic integrated with other components of the computing device/system 800 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, etc. Output device(s) 814 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

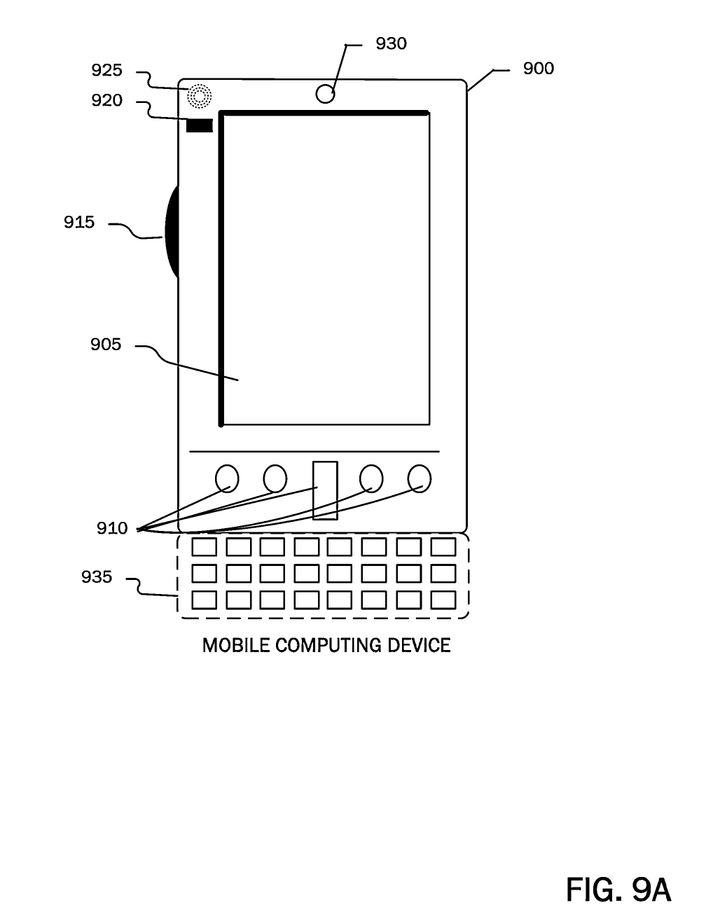

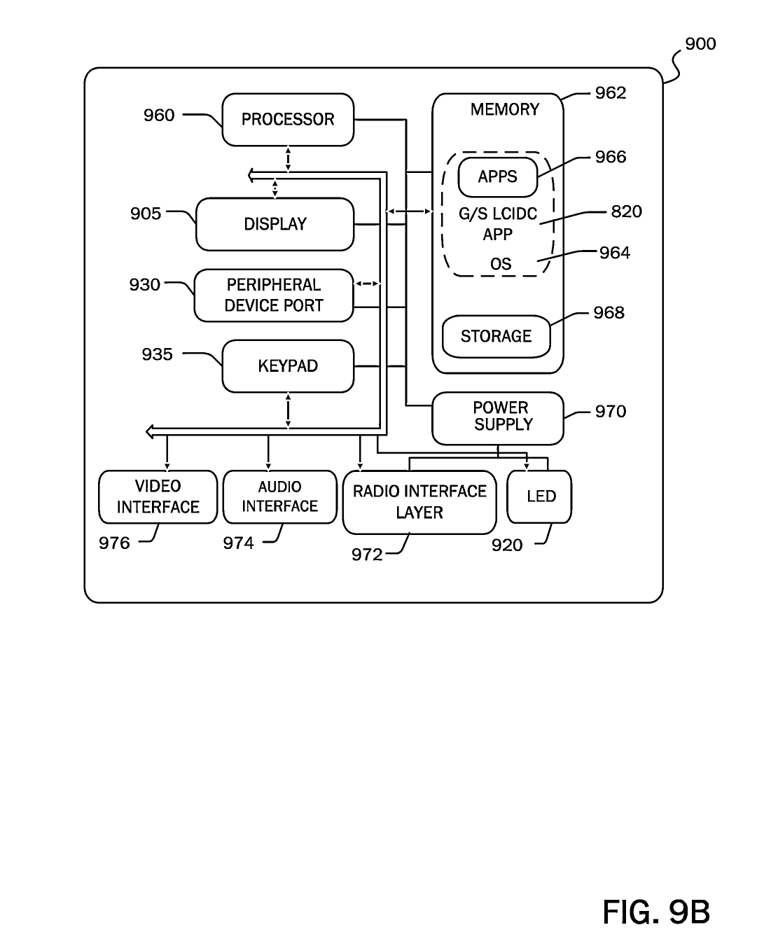

FIGS. 9A and 9B illustrate a suitable mobile computing environment, for example, a mobile telephone 900, a smart phone, a tablet personal computer, a laptop computer, and the like, with which embodiments of the invention may be practiced. With reference to FIG. 9A, an example mobile computing device 900 for implementing the embodiments is illustrated. In a basic configuration, mobile computing device 900 is a handheld computer having both input elements and output elements. Input elements may include touch screen display 905 and input buttons 915 that allow the user to enter information into mobile computing device 900. Mobile computing device 900 may also incorporate an optional side input element 915 allowing further user input. Optional side input element 915 may be a rotary switch, a button, or any other type of manual input element. In alternative embodiments, mobile computing device 900 may incorporate more or less input elements. For example, display 905 may not be a touch screen in some embodiments. In yet another alternative embodiment, the mobile computing device is a portable phone system, such as a cellular phone having display 905 and input buttons 915. Mobile computing device 900 may also include an optional keypad 935. Optional keypad 915 may be a physical keypad or a “soft” keypad generated on the touch screen display.

Mobile computing device 900 incorporates output elements, such as display 905, which can display a graphical user interface (GUI). Other output elements include speaker 925 and LED light 920. Additionally, mobile computing device 900 may incorporate a vibration module (not shown), which causes mobile computing device 900 to vibrate to notify the user of an event. In yet another embodiment, mobile computing device 900 may incorporate a headphone jack (not shown) for providing another means of providing output signals.

Although described herein in combination with mobile computing device 900, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 9B is a block diagram illustrating components of a mobile computing device used in one embodiment, such as the computing device shown in FIG. 9A. That is, mobile computing device 900 can incorporate system 902 to implement some embodiments. For example, system 902 can be used in implementing a “smart phone” that can run one or more applications similar to those of a desktop or notebook computer such as, for example, browser, e-mail, scheduling, instant messaging, and media player applications. In some embodiments, system 902 is integrated as a computing device, such as an integrated personal digital assistant (PDA) and wireless phone.

One or more application programs 966 may be loaded into memory 962 and run on or in association with operating system 964. Examples of application programs include phone dialer programs, e-mail programs, PIM (personal information management) programs, word processing programs, spreadsheet programs, Internet browser programs, messaging programs, and so forth. System 902 also includes non-volatile storage 968 within memory 962. Non-volatile storage 968 may be used to store persistent information that should not be lost if system 902 is powered down. Applications 966 may use and store information in non-volatile storage 968, such as e-mail or other messages used by an e-mail application, and the like. A synchronization application (not shown) also resides on system 902 and is programmed to interact with a corresponding synchronization application resident on a host computer to keep the information stored in non-volatile storage 968 synchronized with corresponding information stored at the host computer. As should be appreciated, other applications may be loaded into memory 962 and run on the device 900, including the life cycle inventory and assessment application 820, described herein.

System 902 has a power supply 970, which may be implemented as one or more batteries. Power supply 970 might further include an external power source, such as an AC adapter or a powered docking cradle that supplements or recharges the batteries.

System 902 may also include a radio 972 that performs the function of transmitting and receiving radio frequency communications. Radio 972 facilitates wireless connectivity between system 902 and the “outside world”, via a communications carrier or service provider. Transmissions to and from radio 972 are conducted under control of OS 964. In other words, communications received by radio 972 may be disseminated to application programs 966 via OS 964, and vice versa.

Radio 972 allows system 902 to communicate with other computing devices, such as over a network. Radio 972 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 902 is shown with two types of notification output devices; LED 920 that can be used to provide visual notifications and an audio interface 974 that can be used with speaker 925 to provide audio notifications. These devices may be directly coupled to power supply 970 so that when activated, they remain on for a duration dictated by the notification mechanism even though processor 960 and other components might shut down for conserving battery power. LED 920 may be programmed to remain on indefinitely until the user takes action to indicate the powered-on status of the device. Audio interface 974 is used to provide audible signals to and receive audible signals from the user. For example, in addition to being coupled to speaker 925, audio interface 974 may also be coupled to a microphone to receive audible input, such as to facilitate a telephone conversation. In accordance with embodiments of the present invention, the microphone 820 may also serve as an audio sensor to facilitate control of notifications, as will be described below. System 902 may further include video interface 976 that enables an operation of on-board camera 930 to record still images, video stream, and the like.

A mobile computing device implementing system 902 may have additional features or functionality. For example, the device may also include additional data storage devices (removable and/or non-removable) such as, magnetic disks, optical disks, or tape. Such additional storage is illustrated in FIG. 9B by storage 968. Computer storage media may include volatile and nonvolatile, removable and non-removable media implemented in any method or technology for storage of information, such as computer readable instructions, data structures, program modules, or other data.

Data/information generated or captured by the device 900 and stored via the system 902 may be stored locally on the device 900, as described above, or the data may be stored on any number of storage media that may be accessed by the device via the radio 972 or via a wired connection between the device 900 and a separate computing device associated with the device 900, for example, a server computer in a distributed computing network, such as the Internet. As should be appreciated such data/information may be accessed via the device 900 via the radio 972 or via a distributed computing network. Similarly, such data/information may be readily transferred between computing devices for storage and use according to well-known data/information transfer and storage means, including electronic mail and collaborative data/information sharing systems.

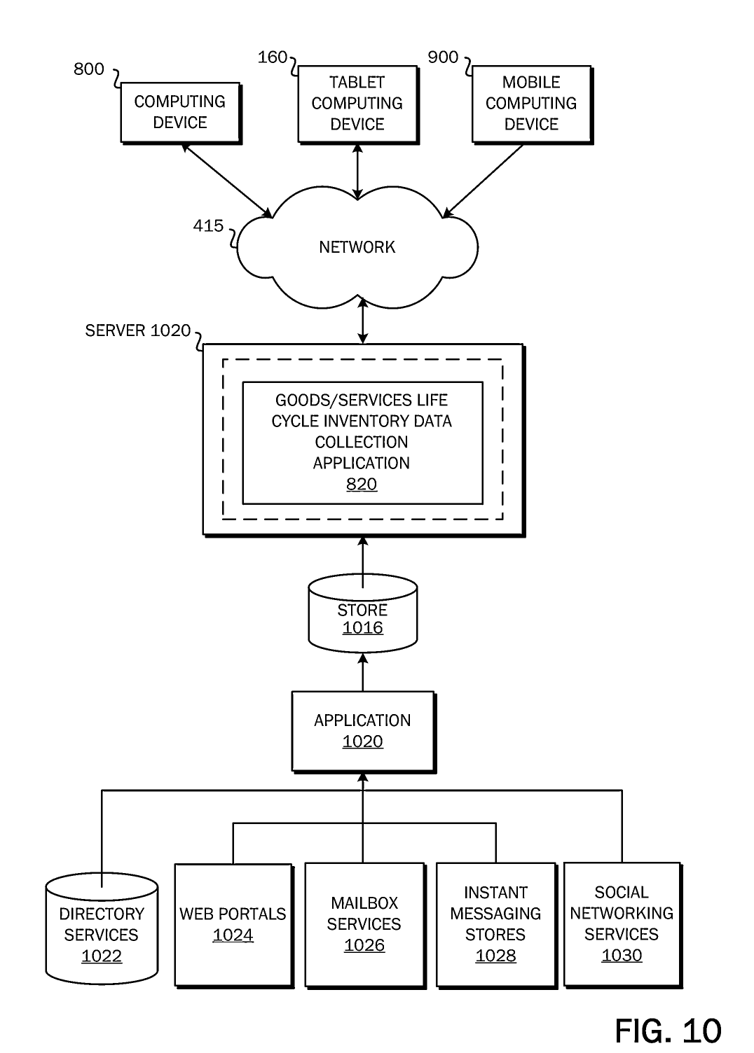

FIG. 10 illustrates a system architecture for providing life cycle inventory and assessment data to one or more client devices, as described above. Content developed, interacted with or edited in association with a life cycle inventory and assessment application 820 may be stored in different communication channels or other storage types. For example, various LCI and LCA items along with information from which they are developed may be stored using directory services 1022, web portals 1024, mailbox services 1026, instant messaging stores 1028 and social networking sites 1030. The life cycle inventory and assessment application 820 may use any of these types of systems or the like for enabling data utilization, as described herein. A server 1020 may provide life cycle inventory and assessment data to clients. As one example, server 1020 may be a web server providing life cycle inventory and assessment data over the web. Server 1020 may provide life cycle inventory and assessment data over the web to clients through a network 415. Examples of clients that may obtain content visualizations include computing device 800, which may include any general purpose personal computer, a tablet computing device 160 and/or mobile computing device 900 which may include smart phones. Any of these devices may obtain content from the store 1016.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

1. A method of collecting life cycle inventory data for a product, comprising:
receiving one or more data items for a first product;
validating the received one or more data items to determine if the received one or more data items may be accepted as life cycle inventory data items for the first product;
comparing the one or more received data items with other data items accepted as life cycle inventory data items of a similar data item type as the received one or more data items to determine whether the received one or more data items may be accepted as life cycle inventory data items for the first product;
if the received one or more data items may be accepted as life cycle inventory data items for the first product, accepting the received one or more data items as life cycle inventory data items for the first product; and
allowing a requesting supplier to retrieve the one or more life cycle inventory data items for use in association with a second product.

2. The method of claim 1, wherein receiving one or more data items for a first product includes receiving the one or more data items via a structured data template.

3. The method of claim 2, wherein receiving the one or more data items via the structured data template includes receiving the one or more data items via the structured data template having one or more structured data fields for receiving the one or more data items.

4. The method of claim 1, prior to receiving one or more data items for a first product, providing a unit process model associated with one or more products of a type to which the first product is associated.

5. The method of claim 4, further comprising providing from the unit process model one or more selectable structured data templates for receiving the one or more data items for the first product.

6. (canceled)

7. The method of claim 1, wherein comparing the one or more received data items with other data items accepted as life cycle inventory data items of a similar data type as the received one or more data items includes comparing one or more attributes of the received one or more data items with one or more corresponding attributes of the other data items accepted as life cycle inventory data items of a similar data item type as the received one or more data items for the first product.

8. The method of claim 7, wherein if the one or more received data items are not accepted as life cycle inventory data items, rejecting the received one or more data items as life cycle inventory data items for the first product.

9. The method of claim 8, further comprising notifying a supplier of the one or more data items that the one or more data items are rejected as life cycle inventory data items for the first product and providing the supplier of the one or more data items for the first product one or more reasons for a rejection of the one or more data items as life cycle inventory data items for the first product.

10. The method of claim 9, in response to notifying the supplier of the one or more data items that the one or more data items are rejected as life cycle inventory data items for the first product, receiving a revised one or more data items for the first product for determining whether the received revised one or more data items for the first product may be accepted as one or more life cycle inventory data items for the first product.

11. The method of claim 1, wherein if the one or more received data items are not accepted as one or more life cycle inventory data items for the first product, auditing the received one or more data items to determine whether the received one or more data items may be accepted as one or more life cycle inventory data items for the first product where the received one or more data items include sufficient information to be categorized as life cycle inventory data items for the first product.

12. The method of claim 1, prior to receiving one or more data items for a first product, determining whether a supplier of the received one or more data items is authenticated to provide the one or more data items for the first product.

13. The method of claim 12, further comprising passing the supplier through a security framework for authenticating an access privilege for the supplier for allowing the supplier to provide the one or more data items for the first product.

14. A computer readable storage medium containing computer executable instructions which when executed by a computer provide a method of collecting life cycle inventory data for a product, comprising:
receiving from a data supplier one or more data items for a first product;
determining whether the data supplier of the received one or more data items is authenticated to provide the one or more data items for the first product.
comparing the one or more received data items with other data items accepted as life cycle inventory data items of a similar data item type as the received one or more data items to determine whether the received one or more data items may be accepted as life cycle inventory data items for the first product;
if the received one or more data items may be accepted as life cycle inventory data items for the first product, accepting the received one or more data items as life cycle inventory data items for the first product;

15. The computer readable storage medium of claim 14, wherein receiving one or more data items for a first product includes receiving the one or more data items via a structured data template.

16. The computer readable storage medium of claim 15, wherein receiving the one or more data items via the structured data template includes receiving the one or more data items via the structured data template having one or more structured data fields for receiving the one or more data items.

17. The computer readable storage medium of claim 14, prior to receiving one or more data items for a first product, providing a unit process model associated with one or more products of a type to which the first product is associated.

18. The computer readable storage medium of claim 17, further comprising providing from the unit process model one or more selectable structured data templates for receiving the one or more data items for the first product.

19. The computer readable storage medium of claim 14, further comprising, upon authentication, allowing a requesting supplier to retrieve the one or more life cycle inventory data items for use in association with a second product.

20. A system for collecting life cycle inventory data for a product, comprising:
a life cycle inventory and assessment data hub coupled with one or more computing devices, the data hub being operative:
receive one or more data items for a first product;
validate the received one or more data items to determine if the received one or more data items may be accepted as life cycle inventory data items for the first product;
compare the one or more received data items with other data items accepted as life cycle inventory data items of a similar data item type as the received one or more data items to determine whether the received one or more data items may be accepted as life cycle inventory data items for the first product;
accept the received one or more data items as life cycle inventory data items for the first product if the received one or more data items are validated and accepted as life cycle inventory data items for the first product;
authenticate access by the requesting supplier to the one or more life cycle data items for the first product; and
allow the requesting supplier to retrieve the one or more life cycle inventory data items for use in association with the second product.

21. The computer readable storage medium of claim 14, wherein comparing the one or more received data items with other data items accepted as life cycle inventory data items of a similar data type as the received one or more data items includes comparing one or more attributes of the received one or more data items with one or more corresponding attributes of the other data items accepted as life cycle inventory data items of a similar data item type as the received one or more data items for the first product.
